(19) United States
(12) Patent Application Publication
(10) Pub. No.: US 2007/0212554 A1
(43) Pub. Date: Sep. 13, 2007

(54) Lecithin additive for coatings

(76) Inventors: Jessica Chen-Ying Yen, Greenville, DE (US); Mia Genevieve Berrettini, Wilmington, DE (US); John Gavenonis, Wilmington, DE (US); Xianjun Jean Meng, Hockessin, DE (US); Dan Qing Wu, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/370,554

(22) Filed: Mar. 8, 2006

(51) Int. Cl. B32B 27/40; B32B 27/32; C08K 5/51

(52) U.S. Cl. 428/423.1; 524/148; 428/500

(57) ABSTRACT

Coating compositions, particularly latex and flat-based coatings, containing lecithin, including but not limited to acylated lecithin and acetylated lecithin, wherein the dried coating has durable improved cleanability and durable improved oil repellency is disclosed.

### FIELD OF THE INVENTION

In a non-limiting way, this invention relates to coating compositions containing lecithin additives that provide durable improved cleanability and oil-repellent surfaces to the dried coating, and the dried coatings derived from such compositions. This invention also relates to coating compositions containing lecithin additives which have been acylated or further acetylated and the dried coating of such compositions.

### BACKGROUND OF THE INVENTION

The coating compositions of interest in the present invention are alkyd coating compositions, urethane coating compositions, water-dispersible coating compositions, and unsaturated polyester coating compositions, typically a paint, clear coating, or stain. All of the above-listed coating compositions after drying or curing often show low hexadecane contact angles, are readily wetted by oil, and are susceptible to soiling. The coating compositions are described in Outlines of Paint Technology (Halstead Press, New York, N.Y., Third edition, 1990) and Surface Coatings Vol. I, Raw Materials and Their Usage (Chapman and Hall, New York, N.Y., Second Edition, 1984).

The rheology of the above described compositions is such that the resulting cured composition is less than desirably uniform. The non-uniformity of such a cured surface causes the contact angle measurement to be low. Contact angle is known to reflect the ability of such a cured surface to be readily cleaned. Cleanability is known to be a description that can be reliably and reproducibly evaluated by testing.

It has been attempted to overcome the problem of lack of uniformity of coating by the addition of a variety of surfactants and other compounds to change the rheology of the composition. Although these additions have produced improvements in the visual appearance of the cured composition, the cleanability of such compositions remains largely unimproved. This is evidenced by the persistence of a low contact angle.

The problem of cleanability has commonly been approached as a separate problem. To improve cleanability, additives have been combined with coating compositions. Such additives have been able to demonstrate cleanability as shown through higher contact angle measurements (U.S. Pat. Nos. 5,637,657 and 5,859,126). However, there still exists a need for improved uniformity of cured coating that will result in higher contact angle measurements and improved cleanability.

In particular the problem of lack of cleanability has not been adequately addressed in flat-based coatings. There exists a need for a flat-based coating with durable improved cleanability.

There exists a need for a coating composition that can be applied to a substrate with conventional means to produce a surface of a dried composition with a uniform distribution of components, especially presenting protective substances that durably resist stains on the surface of said dried surface. It is further desirable to have said stain resistance be demonstrable by improved cleanability.

It is especially desirable to have a flat-based coating composition that produces a dried coating which demonstrates improved cleanability.

Herein are described such compositions. Coating compositions when combined with a lecithin additive, preferably an acylated lecithin additive, most preferably an acetylated lecithin additive, as described herein, result in durable increased cleanability. It is surprising and unexpected that lecithin, a substance commonly used in coating applications as a dispersant, surfactant and/or an emulsifier, would improve cleanability. Dispersants, surfactants, and emulsifiers are known to decrease contact angle measurements. Contact angle is a physical property known to correlate positively with cleanability. Therefore, a decrease in contact angle would be anticipated to interfere with cleanability. One skilled in the art would anticipate lecithin to interfere with cleanability.

### SUMMARY OF THE INVENTION

One aspect of the present invention relates to a coating composition comprising an acylated lecithin additive.

Another aspect of the present invention relates to a flat-based, water-dispersed coating composition comprising a lecithin additive present in a concentration between about 0.5 and about 10.0% by weight of the composition, wherein the additive provides durable improved cleanability.

Still another aspect of the present invention relates to the dried coating of either of the previously mentioned coating compositions.

Still another aspect of the present invention relates to a method of providing improved cleanability to a substrate comprising coating the substrate with a coating composition containing a lecithin additive.

Other advantages will become apparent to those skilled in the art upon reference to the detailed description that hereinafter follows.

### BRIEF DESCRIPTION OF THE FIGURES

FIG. 1 depicts the bar graph of cleanability results by a leneta oil stain test. The values depicted are a relative score of cleanability wherein 0 is uncleanable and 10 is completely cleanable. The numeral values can be found herein in Table 1 in Example 1.

FIG. 2 depicts the bar graph of cleanability results of a leneta oil stain test. The values depicted are a relative score of cleanability wherein 0 is uncleanable and 10 is completely cleanable. The numeral values can be found herein in Table 2 in Example 2.

FIG. 3 depicts the bar graph of results of the Household Stain cleanability test. The values depicted are a relative score of cleanability wherein 0 is uncleanable and 10 is completely cleanable. The numeral values can be found herein in Table 3 in Example 3.

FIG. 4 depicts the bar graph of results of the cleanability for crayon test. The values depicted are a relative score of cleanability wherein 0 is uncleanable and 10 is completely cleanable. The numeral values can be found herein in Table 4 in Example 4.

FIG. 5 depicts the bar graph of results of the durability of cleanability test. The values depicted are a relative score of cleanability wherein 0 is uncleanable and 10 is completely cleanable. The numeral values can be found herein in Table 5 in Example 5.

### DETAILED DESCRIPTION OF THE INVENTION

Trademarks are indicated hereby by capitalization.

This invention comprises coating compositions containing a lecithin additive wherein the composition is an alkyd coating, urethane resin coating, unsaturated polymer coating, latex coating, flat-based coating, and/or water-dispersed coating composition; wherein a dried coating resulting from said coating composition demonstrates improved cleanability in a LENETA oil stain test. Preferably the lecithin additive is acylated, most preferably the lecithin additive is acetylated.

By the term “lecithin”, as used hereinafter, is meant a phosphatide mixture commonly derived from eggs, fish brewers yeast, and vegetable sources, especially soy; however, any phosphatide mixture can be used in the present invention regardless of source. The four major components of such a phosphatide mixture are phosphatidylcholine, phosphatidylethanolamine, phosphatidylinositol, and phosphatidic acid.

The term lecithin as used herein without a modifying adjective may refer to either or both of the acylated and non-acylated forms of lecithin. The term lecithin as used herein without a modifying adjective may refer to either or both of the acetylated and non-acetylated forms of lecithin. Lecithins have been referred to by the following names in some literature: PC-55, Ethanolamine, and Serine.

By the term “acylated lecithin” as used herein is meant a lecithin compound that has been treated with an organic acid anhydride under time and conditions to produce an acylated lecithin product. Following the reaction with organic anhydride a dilute solute of alkali can be added to raise the pH to 7.5-9.0. A more detailed description of the production of acylated lecithin can be found in U.S. Pat. Nos. 3,301,881 and 4,479,977, specifically hereby incorporated by reference.

By the term “acetylated lecithin” as used herein is meant a lecithin compound that has been treated with methyl-containing organic acid, such as acetic acid, under time and conditions to produce an acetylated lecithin product. A more detailed description of the production of acetylated lecithin can be found in U.S. Pat. Nos. 3,301,881 and 4,479,977.

By the term “lecithin additive” as used hereinafter is meant a component of a coating composition which component is composed significantly of lecithin.

By the term “alkyd coating” as used hereinafter is meant a conventional liquid coating based on alkyd resins, typically a paint, clear coating, or stain. The alkyd resins are complex branched and cross-linked polyesters containing unsaturated aliphatic acid residues.

By the term “urethane coating” as used hereinafter is meant a conventional liquid coating based on Type I urethane resins, typically a paint, clear coating, or stain. Urethane coatings typically contain the reaction product of a polyisocyanate, usually toluene diisocyanate, and a polyhydric alcohol ester of drying oil acids.

By the term “unsaturated polyester coating” as used hereinafter is meant a conventional liquid coating based on unsaturated polyester resins, dissolved in monomers and containing initiators and catalysts as needed, typically as a paint, clear coating, or gel coat formulation.

By the term “water-dispersible coating” compositions as used herein is meant surface coatings intended for the decoration or protection of a substrate, comprising essentially an emulsion, latex, or suspension of a film-forming material dispersed in an aqueous phase, and optionally containing surfactants, protective colloids and thickeners, pigments and extender pigments, preservatives, fungicides, freeze-thaw stabilizers, antifoam agents, agents to control pH, coalescing aids, and other ingredients. Water-dispersed coating compositions are exemplified by, but not limited to, pigmented coatings such as latex paints, unpigmented coatings such as wood sealers, stains, and finishes, coating compositions for masonry and cement, and water-based asphalt emulsions. For latex paints the film forming material is a latex polymer of acrylate acrylic, vinyl-acrylic, vinyl, or a mixture thereof. Such water-dispersed coating compositions are described by C. R. Martens in “Emulsion and Water-Soluble Paints and Coatings” (Reinhold Publishing Corporation, New York, N.Y., 1965).

By the term “flat-based” as used herein is meant a coating that has a relatively low gloss among comparable coating compositions. Such low gloss coatings are high in total pigment volume concentration, specifically they are “crowded” systems having a total pigment volume concentration of at least 22%, more specifically at least 40%, and still more specifically at or above the critical total pigment volume concentration which, typically happens at a pigment volume concentration of about 50%, depending upon the properties of the ingredients in the coating. The titanium dioxide loading of the flat-grade coating can be high while the total pigment volume concentration can be at the low end of the range for better opacity. The flat-grade coating typically contains a maximum amount of extenders, such as kaolin clay, which enhance opacity and reduce gloss. The flat-grade coating can have a sheen below about 15%, measured on an 85° glossmeter, more typically below about 10%.

By the term “coating composition” as used herein, is meant a liquid formulation of alkyd coating, urethane coating, water-dispersible coating, latex coating, flat-based coating, and/or unsaturated polyester coating, as applied to a substrate for the purpose of creating a lasting film on said surface.

By the term “dried coating” as used herein is meant the final decorative and/or protective film obtained. Such a final film can be achieved by, for non-limiting example, curing, coalescing, polymerizing, interpenetrating, and/or evaporation. Final films can also be applied in a dry and final state as in dry coating for a non-limiting example.

By the term “improved cleanability” as used herein is meant that the additive demonstrates an improvement of the composition's performance when compared to a substantially similar coating that does not contain said additive. Such improvement is preferably evaluated by the LENETA oil stain test for cleanability as described herein.

The coating compositions of the present invention are useful for providing a protective and/or decorative coating to a wide variety of substrates. Such substrates include primarily construction materials and hard surfaces such as wood, metal, wallboard, masonry, concrete, fiberboard, paper, and other materials. Upon application, such coating compositions dry or cure by conventional methods and the dried coatings of the present invention exhibit several valuable properties. Specifically, the dried coatings of this invention, compared with the conventional dried coatings, exhibit improved oil repellency and durability thereof, as demonstrated by experimental result. The improved repellency results in improved cleanability of the surface of the cured coating. The lecithin additives of the present invention are useful as components of the coating compositions.

Although not wishing to be bound by theory, it is believed that the lecithin additives change the rheology of the liquid composition. Lecithin additives change the surface free energy. This increased fluid flow allows the binder, pigments, dyes, catalysts, thickeners, stabilizers, emulsifiers, texturizers, adhesion promoters, flatteners, and other components of the composition, if present, to distribute more uniformly over the surface to which it is applied. After drying, the coating containing the lecithin additive produces a coating surface that is more uniform in the dispersal of the binder, pigments, and other composition components than the same composition without a lecithin additive. The more uniform surface exhibits increased resistance to hydrophobic substances. The long hydrophobic tail of the lecithin, particularly the hydrophobicity of the acylated and acetylated form of lecithin, interact with oil-based stains to increase repellency to these high molecular weight stains. The increase in repellency is demonstrated by improved cleanability. Typically the dried coating resulting from a lecithin additive containing composition increases cleanability by either 50% or more, or 1 point or more as demonstrated by the LENETA oil test on a 0 to 10 point scale.

The present invention provides a dried coating surface that is chemically stable which provides durable improved cleanability and improved oil repellency. By durable improved cleanability and durable repellency it is meant that the advantageous surface properties of the dried coatings of the present invention are retained following various simulations of surface cleaning. Thus the improved cleanability and repellency are retained after conventional washing of the surface.

The coating compositions of this invention contain sufficient lecithin additive such that the coating composition contains, by weight in the content of the composition, from about 0.1 to about 10.0% lecithin additive, or preferably from about 0.1 to about 5.0% lecithin additive, or more preferably from about 0.5 to about 5.0% lecithin additive, or more preferably from about 1.0 to about 5.0% lecithin additive, or most preferably from about 1.0 to about 2.0% lecithin additive. For some applications the range of between about 2.0% to about 5.0%, or more preferably from about 3.0% to about 5.0% by weight, provides substantial benefit. For certain embodiments of the present invention the preferred range of lecithin additive can combine the ranges described here.

The dried coating of the present invention resulting from said composition has a durable improved cleanability of about 1 point or more on a 0 to 10 point scale in a LENETA oil stain test when compared to an untreated coating composition. Preferably the present invention imparts an improvement of 2 points or more on a 0 to 10 point scale in a LENETA oil stain test when compared to an untreated coating composition. Most preferably, the present invention imparts a 3 point or greater improvement on a 0 to 10 point scale in a LENETA oil stain test when compared to an untreated coating composition. Also preferable is the embodiment of the present invention which demonstrates a 50% improvement in a LENETA oil stain test when compared to an untreated coating composition. For certain embodiments of the present invention the preferred range of improved cleanability can combine the ranges described here.

The lecithin additives are effectively introduced to the coating composition base by thoroughly stirring lecithin, in a powder, triglyceride containing solution, or other form, into the composition at room temperature. More elaborate mixing can be employed such as using a mechanical shaker or providing heat or other methods. Such methods are not necessary and do not substantially improve the final composition.

The lecithin additives can be added to commercially available coating compositions prior to use while still providing oil repellency and improved cleanability. The additive can be added during the preparation of a coating composition or to a prepared coating composition with equal efficacy. The lecithin additive is effective if it is thoroughly mixed into the prepared composition by shaking, stirring, or equivalent means.

Any lecithin can be used as a lecithin additive in the present invention. Lecithin is commercially available from the following companies: The Solae Company, St. Louis, Mo.; Unimills, Zwijndrecht, the Netherlands; Lucas Meyer GmbH & Co., Hamburg, Germany; N.V. Vamo Mills, Izegem, Belgium; Unitechem Chemical Co., Ltd., Tianjin China; PanChem (Tianjin) International Trading and Industrial Co. LTD, Teda, Tianjin, China; Fraken Biochem Co., Ltd. Qingdao, Shandong, China. The Solae Company (St. Louis, Mo.) is the preferred manufacturer of lecithin for use as the lecithin additive in the present invention. Naturally occurring lecithin can be found in, for example, eggs, soybean oil, legumes, grains, wheat germ, nuts, seeds, fish, and brewers yeast. Lecithin isolated from soybean oil is preferred for use with the present invention.

Lecithin is a mixture of phosphatides. The four major components of such a phosphatide mixture are phosphatidylcholine, phosphatidylethanolamine, phosphatidylinositol, and phosphatidic acid.

Phosphatidylcholines should generally follow this formula: 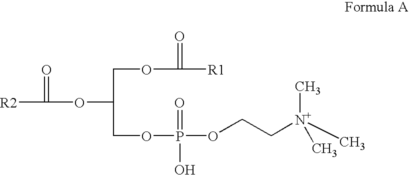
wherein

R1 and R2 are about a C₈ to about a C₃₀ carbon chain.

Phosphatidylethanolamines should generally follow this formula: 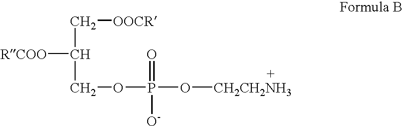
wherein

R′ and R″ are about C₆ to about a C₁₈ carbon chains.

Phosphatidylinositols should generally follow this formula: 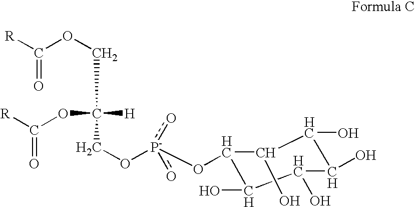
wherein

R represents carbon chains of about 8 carbons to about 30 carbons in length.

Phosphatidic acids should generally follow this formula: 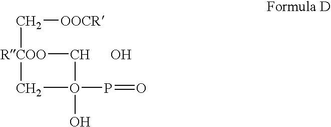
wherein

R′ and R″ are carbon chains of about 8 carbons to about 30 carbons in length.

More preferably the lecithin used with the present invention is an acylated lecithin. Such acylated lecithins are not naturally occurring, however, they are known and described in the art. Acylated lecithin is produced by first obtaining lecithin hydrates from the degumming of crude soybean oil. The acylation process is begun by adding 2-5% of an organic anhydride, acetic anhydride is most preferred, to the lecithin hydrate. The amount of organic anhydride needed generally depends on the level of phosphatides in the gums. Sufficient organic anhydride should be added so that the final product will have, but not be limited to, an amine nitrogen content of about 1.2 mg nitrogen or less per gram of product. Amine nitrogen is determined by formol titration, as described in U.S. Pat. No. 3,301,881.

Optionally, following the reaction with organic anhydride, a dilute solution (1-30%) of an alkali base (15% NaOH or KOH are preferred) is added to raise the pH to 7.5-9.0, preferably 7.5 to 8.5. The product is then vacuum-dried at 28″ Hg (94.82 kPa) vacuum and 150-250° F. (66-121° C.) to a final moisture within Food Chemicals Codex (FCC) III lecithin specifications. This processing method allows the resulting product to be clear.

Fluidity and phase stability are established via the addition of fatty acids and soybean salad oil (or other oleaginous oils) to a percent acetone insolubles (AI) of about 50-66% (preferably 55%) and to less than 36 acid value (AV). The final product will have viscosities in the range of 1,000-10,000 centipoise (optimally 2000-3000 centipoise; Brookfield LVT, Brookfield Engineering Company, Spindle 4, 30 rpm, 25° C.). These products maintain a clear single phase upon storage from −30 to 150° F. (−34 to 66° C.).

Most preferable the lecithin used with the present invention is acetylated lecithin. Acetylated lecithin can be produced using the methods described above for producing acylated lecithin wherein the organic anhydride is acetic anhydride.

Many of the coating compositions of the present invention further comprise a pigment. Any pigment can be used with the present invention. The term “pigment” as used herein means opacifying and non-opacifying ingredients which are particulate and substantially non-volatile in use. Pigment as used herein includes ingredients labeled as pigments, but also ingredients typically labeled in the coating trade as inerts, extenders, fillers, and similar substances.

Representative pigments that can be used with the present invention include, but are not limited to, rutile and anatase TiO₂, clays such as kaolin clay, asbestos, calcium carbonate, zinc oxide, chromium oxide, barium sulfate, iron oxide, tin oxide, calcium sulfate, talc, mica, silicas, dolomite, zinc sulfide, antimony oxide, zirconium dioxide, silicon dioxide, cadmium sulfide, cadmium selenide, lead chromate, zinc chromate, nickel titanate, diatomaceous earth, glass fibers, glass powders, glass spheres, MONASTAL Blue G (C.I. Pigment Blue 15), molybdate Orange (C.I. Pigment Red 104), Toluidine Red YW (C.I. Pigment 3)-process aggregated crystals, Phthalo Blue (C.I. Pigment Blue 15)-cellulose acetate dispersion, Toluidine Red (C.I. Pigment Red 3), Watchung Red BW (C.I. Pigment Red 48), Toluidine Yellow GW (C.I. Pigment Yellow 1), MONASTRAL Blue BW (C.I. Pigment Blue 15), MONASTRAL Green BW (C.I. Pigment Green 7), Pigment Scarlet (C.I. Pigment Red 60), Auric Brown (C.I. Pigment Brown 6), MONASTRAL Green G (C.I. Pigment Green 7), MONASTRAL Maroon B, MONASTRAL Orange, and Phthalo Green GW 951.

Titanium dioxide (TiO₂) is the preferred pigment to use with the present invention. Titanium dioxide pigment, useful in the present invention, can be in the rutile or anatase crystalline form. It is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley & Sons, NY (1988), the teachings of which are incorporated herein by reference.

Titanium dioxide particles have an average size of generally less than 1 micron but can vary up to as large as an average size of 10 microns. Preferably, the particles have an average size from about 0.020 to about 0.95 microns, more preferably, from about 0.050 to about 0.75 microns and most preferably from about 0.075 to about 0.50 microns.

If the pigment is titanium dioxide it can be substantially pure titanium dioxide or can contain other metal oxides, such as silica, alumina, zirconia, and the like. Other metal oxides can become incorporated into the pigment particles for example, by co-oxidizing or co-precipitating titanium compounds with other metal compounds. If co-oxidized or co-precipitated metals are present, they are preferably present in an amount from about 0.1 to about 20 percent by weight, as the metal oxide, preferably, from about 0.5 to about 5 percent by weight, more preferably from about 0.5 to about 1.5 percent by weight based on the total pigment weight.

The titanium dioxide pigment can also bear one or more metal oxide surface coatings. These coatings can be applied using techniques known by those skilled in the art. Examples of metal oxide coatings include silica, alumina, and zirconia, among others. Such coatings can be present in an amount from about 0.1 to about 10 percent by weight, based on the total weight of the pigment, preferably from about 0.5 to about 3 percent by weight.

The titanium dioxide pigment is surface treated. By “surface treated” it is meant titanium dioxide pigment particles that have been contacted with the compounds described herein wherein the compounds are adsorbed on the surface of the titanium dioxide particle or a reaction product of at least one of the compounds with the titanium dioxide particle is present on the surface as an adsorbed species or chemically bonded to the surface. The compounds or their reaction products or combination thereof can be present as a coating, either single layer or double layer, continuous or non-continuous, on the surface of the pigment. Typically, a continuous coating comprising a silicon-containing compound and an organic compound is on the surface of the pigment.

Non-limiting commercial examples of such coated titanium dioxide pigments include TI-PURE R706 and TI-PURE R931, available from E. I. du Pont de Nemours and Company, Wilmington, Del.; TIOXIDE R-XL and R-HD4, available from Huntsman Tioxide, Billingham, England; TIONA RCL-3, RCL-376, and RCL-373 available from Millennium Chemicals, Inc., Hunt Valley, Md.; KRONOS 2044, 2131, 2043, and 2047, available from Kronos Worldwide, Incorporated, Dallas, Tex.; TIPAQUE R-780 and R-780-2 available from Ishihara Sangyo Kaisha, Limited, Osaka, Japan; KEMIRA RDE2, RDD, RDD1, OR-572, and OR-573 available from Kemira Oyj, Helsinki, Finland; PGE-113 available from Cristal, Jeddah, Saudi Arabia; JR-800 and JR-801 available from Tayca Corporation, Osaka, Japan; R-7E available from Sakai Chemical Industry Company, Limited, Osaka, Japan; TYTANPOL R-211 available from LG Chem, Seoul, Korea; KEMOX CR-813 available from Kerala Minerals and Metal, Limited, Kollam, India; RC84 available from Cinkarna, Celje, Slovenia; and CR-813, RD, and R-500, available from Kerr-McGee Corporation, Oklahoma City, Okla.

The present invention can by used in almost any coating. For non-limiting examples, it can be used with an alkyd coating, a urethane coating, an unsaturated polyester coating, a water dispersible coating, a latex coating, and a flat-based coating. The use of the present invention with a flat-based coating is preferred.

Conventional alkyd coatings utilize, as the binder or film-forming component, a curing or drying alkyd resin. Alkyd resin coating compositions contain unsaturated aliphatic acid residues derived from drying oils. These resins spontaneously polymerize in the presence of oxygen or air to yield a solid protective film. The polymerization is termed “drying” or “curing” and occurs as a result of autoxidation of the unsaturated carbon-carbon bonds in the aliphatic acid component of the oil by atmospheric oxygen. When applied to a surface as a thin liquid layer of formulated alkyd coating, the cured films that form are relatively hard, non-melting, and substantially insoluble in many organic solvents that act as solvents or thinners for the unoxidized alkyd resin or drying oil. Such drying oils have been used as raw materials for oil-based coatings and are described in the literature.

Urethane coatings are classified by ASTM D-1 into five categories. Type I urethane coatings contain a pre-reacted autoxidizable binder as described in Surface Coatings Vol. I, previously cited. Type I urethane binders, also termed urethane oils, oil-modified polyurethanes, or urethane alkyds, are the largest volume category of polyurethane coatings and include typical paints, clear coatings, or stains. Urethane coatings typically contain the reaction product of a polyisocyanate, usually toluene diisocyanate, and a polyhydric alcohol ester of drying oil acids. The cured coating is formed by air oxidation and polymerization of the unsaturated drying oil residue in the binder.

Unsaturated polyester resins contain as the unsaturated prepolymer the product obtained from the condensation polymerization of a glycol such as 1,2-propylene glycol or 1,3-butylene glycol with an unsaturated acid such as maleic (or of maleic and a saturated acid, e.g., phthalic) in the anhydride form. The unsaturated prepolymer is a linear polymer containing unsaturation in the chain. This is dissolved in a suitable monomer, for instance styrene, to produce the final resin. The film is produced by copolymerization of the linear polymer and monomer by means of a free radical mechanism. The free radicals can be generated by heat, or more usually by addition of a peroxide, such as benzoyl peroxide, separately packaged and added before use. Such coating compositions are frequently termed “gel coat” finishes. In order that curing can take place at room temperature, the decomposition of peroxides into free radicals is catalyzed by certain metal ions, usually cobalt. The solutions of peroxide and cobalt compound are added separately to the mix and well stirred before application. The unsaturated polyester resins that cure by a free radical mechanism are also suited to irradiation curing using, for instance, ultraviolet light. This form of cure, in which no heat is produced, is particularly suited to films on wood or board. Other radiation sources, for instance electron-beam curing, are also used.

Water-dispersible coating compositions are composed of water as an essential dispersing component. “Water-dispersible coating composition” is a general classification that describes a number of formulations and may include members of the above described classifications as well as members of other classifications. Water-dispersible coating compositions consist essentially of an emulsion, latex, or suspension of a film-forming material dispersed in an aqueous phase, and generally containing other common coating ingredients. Water-dispersed coating compositions are exemplified by, but not limited to, pigmented coatings such as latex paints, unpigmented coatings such as wood sealers, stains, and finishes, coating compositions for masonry and cement, and water-based asphalt emulsions.

The additives of the invention can be used with latex coating compositions. A latex coating composition typically comprises a latex binder, pigment including opacifying pigment or colored pigment in a tint base coating composition, extender pigment, dispersant, thickener, coalescing agent, defoamer, preservative, water, and other additives to achieve good film-forming and dry film properties.

Latex coating compositions can have different sheen levels, which usually are described as gloss, semigloss, satin, eggshell, and flat bases. Sheen level is measured on a dry coating with a glossmeter. Gloss, which is defined as the percentage of light reflected from a dry coating surface, is measured typically at 20°, 60° and 85°. A flat based latex paint composition typically has 85° gloss below 15%, more typically, below 10%.

The binders used in latex coating compositions typically are colloidal dispersions of high molecular weight polymer made by emulsion polymerization.

Representative binders used in architectural coating compositions can be polymers made from three types of monomers: acrylic, vinyl acetate, and styrene-butadiene.

Typical acrylic monomers include acrylic acid, methyl acrylate, ethyl butyl acrylate, 2-ethylhexyl acrylate, hydroxyethyl acrylate, hydroxylbutyl acrylate, methacrylic acid, methyl methacrylate, ethyl methacrylate, butyl methacrylate, hydroxyethyl methacrylate, and hydroxybutyl methacrylate. Acrylonitrile and styrene can also be used with acrylates.

A vinyl acetate binder can either be a homopolymer or a copolymer that can also contain vinyl butyrate, vinyl methyl ether, vinyl chloride, vinyl fluoride, ethylene, dibutyl fumerate, dibutyl maleate, vinyl stearate, and acrylates or methacrylates. More recently, vinyl ester of varsatic acid (VEOVA) is also used as a co-monomer.

Specific examples of all acrylic binders include PRIMAL SF-016, available from the Rohm and Haas Company, Philadelphia, Pa., and UCAR Latex 629, from Dow Chemical, Midland, Mich.

A specific example of a vinyl acrylic binder includes UCAR Latex 300, available from Dow Chemical, Midland, Mich.

A specific example of a styrene acrylic binder includes UCAR Latex DA27, available from Dow Chemical, Midland, Mich.

Most effective and preferred opacifying pigments are rutile and anatase titanium dioxide particulates. Especially preferred is rutile titanium dioxide having an average particle diameter of less than about 5,000 Å (500 nm) and typically having a particle size of about 1,000 (100 nm) to about 5,000 Å (500 nm). Particle size diameter can be measured by well known techniques such as laser light scattering based Microtrac S3500, Microtrac, Inc., Montgomeryville, Pa.

The latex coating composition of this disclosure can optionally contain one or more surfactants, which are used primarily to disperse pigments, such as fortified sodium ether alcohol sulfate, DUPONOL RA, ethylene oxide, ester condensate MERPOL A, polyether MERPOL LF-H, alcohol ethoxylate MERPOL SE, ethylene oxide condensate MERPOL SH, alcohol phosphate composition ZELEC NK, available from E. I. du Pont de Nemours and Company, Wilmington, Del.; acetylenic diol, SURFYNOL CT-111, ethoxylated tetramethyl decynediol, SURFYNOL 465H, acetylenic diol, anionic surfactant blend, SURFYNOL CT-136, and other acetylenic diol blends such as SURFYNOL GA and TG (an acetylenic diol blend in ethylene glycol) available from Air Products and Chemicals, Incorporated, Allentown, Pa.; diocyl ester of sodium sulfonsuccinic acid, AEROSOL OT, dihexyl ester of sodium sulfosuccinic acid, AEROSOL MA-80 available from Cyanamid, Wayne, N.J.; polyethylene glycol such as 3350, 400, and 600 sold by Fisher Scientific, Hampton, N.H.; polyoxyethylene (12) tridecyl ether RENEX 30 and polyoxyethylene alkyl alcohol SYNTHRAPOL KB sold by ICI Americas Inc., Wilmington, Del.; the alkyl aryl polyether alcohols TRITON X100 and X405, nonylphenoxy polyethoxy ethanol TRITON N111, octylphenoxy polyethoxy ethanol TRITON X102, octylphenoxy polyethoxy ethanol TRITON X114, sold by Dow Chemical Company, Midland, Mich.; the polyalkylene oxide modified polydimethylsiloxanes SILWET L-7600, L-77, and L-7607 and polyalkylene glycol UCON ML1281 sold by Dow Chemical Company, Midland, Mich.; lauryoyl iminodiacetic acid HAMPOSYL Lida sold by W.R. Grace, Hampshire Division, Columbia, Md.; silicones such as BYK-307 sold by BYK-Chemie, Wesel, Germany; and alcohol ethoxylate such as TERGITOL 15-S-9 sold by Dow Chemical Company, Midland, Mich.

A representative coalescing agent that assists in film formation is TEXANOL, available from Eastman Chemicals, Kingsport, Tenn.

Glycols used to aid in wet edge retention and as an anti-freeze can be ethylene glycol or propylene glycol.

Preservatives which preserve latex coatings from microbial growth and fungal/mildew attack on the dried coating film can include without limitation 1,2-benzisothiazolin-3-one such as PROXEL GXL and PROXEL Avecia sold by Arch Chemicals, Wilmington, Del.; 5-chloro-2-methyl-4-isothiazolin-3-one such as KATHON LX sold by Rohm and Haas, Philadelphia, Pa.; 1,2-dibromo-2,4-dicyanobutane; 2-bromo-2-nitropropane-1,3-diol; BRONOPOL; TEKTAMER; DOWICIDES sold by Dow Chemicals, Midland, Mich.; OMIDINES sold by Olin Corporation, Cheshire, Conn.; NOPCOCIDES sold by Henkel Corporation, Ambler, Pa.; TROYSANS, Troy Chemical Corporation, Newark, N.J.; and sodium benzoate.

Thickeners can be used such as hydroxyethyl cellulose, Natrosol sold by Hercules Inc., Passaic, N.J.; colloidal attapulgite clay, MIN-U-GEL 400 sold by Floridin, Quincy, Fla.; synthetic smectite clay, LAPONITES, sold by Southern Clay Products, Inc., Gonzales, Tex.; hydrophobically modified alkali soluble emulsions (HASE thickeners), ACRYSOLS TT-615, TT-935, and RM-5 rheology modifiers sold by Rohm and Haas, Philadelphia, Pa.; hydrophobically modified ethylene-oxide base urethanes (Heur thickeners), ACRYSOLS RM-825, and RM-1020, sold by Rohm and Haas, Philadelphia, Pa.; cellulosic thickeners including methylcellulose; and fillers such as calcined clay, silica, and calcium carbonate.

A latex coating composition can also include a defoamer including polysiloxanes such as DEHYDRAN and DEHYDRAN 1620 and a blend of silica and organic solids such as DREWPLUS L464 sold by Drew Industrial, Dublin, Ohio. Typically, the defoamer is used in an amount ranging from about 20 to about 1000 ppm, more typically about 100 ppm.

Wetting and leveling agents can be used and including ZONYL FS-610, a fluorochemical from E. I. du Pont de Nemours and Company, Wilmington, Del.

Sequestering agents can be used such as ethylenediamine triacetic acid (EDTA) to eliminate the deleterious effects of any metallic impurities. Buffering agents can be used such as 2-amino-2-methyl-1-propanol (AMP-95).

Other components and adjuvants well known in the relevant art can also be added. Additional dispersants can be added, if desired.

U.S. Pat. No. 3,591,398, hereby specifically incorporated by reference, discloses a process for making a flat-grade-pigment that can be used in this invention. The flat-grade-pigment described in the '398 patent comprises TiO₂ flat-grade-pigment particles having a high hiding power. In general, the barrier layer is provided by treating base titanium dioxide particles with a source of soluble silica and alumina. Examples of suitable sources of silica include potassium or sodium silicate. Examples of suitable sources of alumina include aluminum sulfate and sodium aluminate. The titanium dioxide is treated by adding to a pigment slurry (aqueous mixture of the particles maintained at a pH of 4 to 8) a solution of soluble silicate and/or aluminate in an amount calculated to provide from about 5 to about 40 percent by weight of silica calculated as SiO₂, and from about 5 to about 40 percent by weight of alumina calculated as Al₂O₃ based on the weight of the titanium dioxide particles. The titanium dioxide can be treated with silica and alumina added separately or simultaneously. The barrier layer is considered voluminous because it has a high volume and can comprise many voids or convolutions. Additionally, the barrier layer can be considered rigid and sponge-like.

The present invention further comprises a method of providing durable oil repellency and improved cleanability to a substrate comprising coating the substrate with a coating composition containing a lecithin additive as described above. Methods of application of the coating compositions to surfaces and the drying properties of the coating compositions are essentially unaffected by the addition of the lecithin additives. The coating compositions of the present invention are applied to the substrate by conventional methods. After drying, the dried coating has durable oil repellency and improved cleanability. These desirable attributes remain after repeated cleaning as demonstrated by experimental example.

The present invention further comprises a dried coating comprising the protective film obtained after the volatile components of a coating composition containing a lecithin additive, as described, have evaporated, vaporized, coalesced, or otherwise dissipated.

### Test Methods

Method 1—Leneta oil Stain Test

The test method described herein is a modification of ASTM 3450-00—Standard Test Method for

Washability Properties of Interior Architectural Coatings, which is hereby specifically incorporated by reference.

Drawdowns were prepared by applying a coat of coating composition on LENETA Black MYLAR cards (The Leneta Company, Mahwah, N.J.) using a BYK-Gardner automatic drawdown machine (BYK-Gardner, Silver Spring, Md.) and a 5 mil (0.127 mm) Bird applicator drawdown blade (BYK-Gardner, Silver Spring, Md.). The drawdown speed was set to be slow enough to prevent pinholes or holidays in the resulting coating. Several drawdowns were prepared for each paint and additive combination. The coated cards were allowed to dry for seven days for testing for cleanability.

Staining media were prepared using VASELINE NURSERY JELLY (Marietta Corporation, Cortland, N.Y.) and LENETA Carbon Black Dispersion in Mineral Oil (ST-1) (The Leneta Company, Mahwah, N.J.). The petroleum jelly was melted in a clean glass container for 30 minutes in an oven set at 70° C. Then the petroleum jelly was mixed with 5% of its weight of LENETA Carbon Black. For instance, 95 g of petroleum jelly was mixed with 5 g of LENETA Carbon Black to produce 100 g of staining media. The mixed staining media was cooled for several hours in a refrigerator at 4° C.

Cleaning media were prepared using a JOY ULTRA CONCENTRATED COUNTRY LEMON dishwashing liquid (The Procter & Gamble Company, Cincinnati, Ohio). Dishwashing liquid was mixed with deionized water at a ratio of 1 g of dishwashing liquid for every 99 g of water.

Staining and Cleaning.

Each drawdown was stained in the same manner. A staining template was prepared from a MYLAR LENETA card by cutting out a 3″ by 1″ (7.6 cm by 2.5 cm) strip from the interior of the card. The template was placed over a coated drawdown card to be stained. Staining media was spread over the drawdown card and the template using a spatula so that none of the drawdown card remained visible. Excess stain was removed with a spatula. Stained cards were allowed to set and dry for 60 minutes.

In preparation for cleaning, scrap MYLAR was used to gently scrape the excess dried stain from the whole surface card, both the washed and unwashed sections. Similarly, a c-folded clean paper towel was used to remove unset stain from the entire card, including both the washed and unwashed sections. The card was then securely attached to a BYK-Gardner Abrasion tester (BYK-Gardner, Silver Spring, Md.). A piece of cheesecloth (VWR International, San Diego, Calif.) was attached to the cleaning block on the abrasion tester. The cheesecloth was folded and attached so that the contacting surface was 8 layers thick. 10 mL of cleaning solution prepared as specified above was applied to the contacting surface of the cheesecloth. The abrasion tester was run through 5 cycles (10 wipes) over a stained section of the drawdown card that is henceforth designated as stained and cleaned. Excess cleaning solution was rinsed away with deionized water for a few seconds and then allowed to dry for 2 hours or until completely dry by visible inspection. One section of each stained drawdown card was cleaned in this manner.

Cleanability was determined by evaluating the stained and washed painted portion of the drawdown card in comparison to both the unstained and painted portion of the card and the stained and unwashed painted portion of the card. A HunterLab ULTRASCAN Pro calorimeter (Hunter Associates Laboratory, Inc, Reston, Va.) was used to take three different measurements for each designated painted portion of the drawdown card: stained and washed, unstained, and stained and unwashed. The measurements were averaged to obtain a mean value for that section that is used to evaluate the cleanability rating for that card as described below. The calorimeter was set to read the L* function and the aperture was no larger than ¾ of an inch (1.9 cm).

A cleanability score was calculated ranging from 0-10 wherein 0 is uncleanable, and 10 is completely cleanable. Values 1-9 were established in numerical order equidistant from 0, 10, and one another on a linear slope. The above description fits the following equation: [(mean L*value of stained and washed painted section)−(mean L*value of stained and unwashed painted section)]/[(mean L*value of unstained painted section)−(mean L*value of stained and unwashed painted section)]*10=cleanability rating.

Method 2—Detergent Wash Durability

Wash durability of the lecithin-containing coating compositions to surface cleaning was determined using a GARDCO Model D10 Wash & Wear Tester (Paul N. Gardner Co., Pompano Beach, Fla.) and a Gardco WA-2225 abrasion boat. A 6.5×1 inch (16.5×2.5 cm) test strip cut from the coated LENETA test panel was positioned on the test sample tray and fastened thereto with ¾ inch (1.9 cm) wide transparent tape such that about a 2×¾ inch (5.1×1.9 cm) portion of the coated test panel would be scrubbed. The abrasion boat base plate was covered with a folded 9×9 inch (22.9×22.9 cm) piece of De Royal Textiles IDEALFOLD bleached grade 20B cotton cheesecloth available from DeRoyal Textiles, Camden, S.C. The cheesecloth was folded perpendicular to the seam in half, and half again, and was fastened to the base plate such that the scrubbing surface layers were seam free. The cheesecloth pad was wet with 20 ml of a 1% aqueous JOY detergent (Procter & Gamble Co., Cincinnati, Ohio) solution as described above before the test strip was scrubbed. The test strip was removed after a predetermined number of scrub cycles, washed free of the JOY solution with water, and air dried one day before the test strips were evaluated using the Leneta oil Stain test, Test Method 1, described above.

Method 3—Household Stain Test

The test method described herein is a modification of ASTM 4828-94—Standard Test Method for Practical Washability of Organic Coatings, which is hereby specifically incorporated by reference.

MYLAR Cards were prepared as in Test Method 1.

Staining was performed using a variety of common stain materials. The each stain was applied to a 1 inch (2.54 cm) band running the length of the panel. The panel was allowed to set for 2 hours.

One portion of the marked panel was cleaned as described in Test Method 1. At least three tests were performed for each set of conditions.

The cleanability rating was determined using a visual rating system, which has a relative range from 0 to 10. The score 10 indicates that the cleaned stained portion of LENETA card appears to be identical to the unwashed and unstained portion of the card. The score 0 indicates that the cleaned stained portion of LENETA card appears to be identical to unwashed and stained portion of the card. The score 1-9 was assigned as estimate the percentage of stain was removed with cleaning. A set of LENETA strips with established cleanability ratings were prepared to aid visual cleanability evaluation.

### Materials

The following materials were employed in the examples hereinafter unless otherwise indicated.

A. Coating Compositions (Paints)

Paint #1) Styrene Acrylic resin, 2.2% gloss at 85°.

Paint #2) Acrylic resin, 3.9% gloss at 85°.

Paint #3) Acrylic resin, 4.8% gloss at 85°.

Paint #4) Vinyl Acrylic resin, 1.8% gloss at 85°.

Paint #5) Styrene Acrylic resin, 2.0% gloss at 85°.

Paint #6) Styrene Acrylic resin, 2.3% gloss at 85°.

B. Additives

1) Lecithin additive 1, The Solae Company, St. Louis, Mo., is an acetylated lecithin additive as described in U.S. Pat. Nos. 3,301,881 and 4,479,977. This additive is noted in the Tables and Drawings as “Lecithin”.

C. Stains

1) Leneta Carbon Black Dispersion in Mineral Oil (ST-1), The Leneta Company, Mahwah, N.J.

2) Vaseline Nursery Jelly, Marietta Corporation, Cortland, N.Y.

3) Blue or black CRAYOLA crayon, Binney & Smith, Easton, Pa.

4) Lipstick, COVERGIRL Really Red 575, Procter & Gamble, Cincinnati, Ohio.

5) Graphite Pencil, #2 or HB.

6) Blue or black CRAYOLA washable marker, Binney & Smith, Easton, Pa.

7) SMUCKER'S Concord Grape Jelly, The J.M. Smucker Company, Orrville, Ohio.

8) Ketchup, H.J. Heinz Company, Pittsburgh, Pa.

D. Cleaning Compositions

1) JOY Ultra Concentrated Country Lemon dishwashing liquid, The Procter & Gamble Company, Cincinnati, Ohio.

### EXAMPLES

### Example 1

The coatings, additives, stains, and cleaning agents used in this example are those described in the Materials section. The samples used in this example were prepared according to description listed in Table 1. The described additives were added by percent weight and thoroughly mixed by mechanical shaking. Care was taken to prevent the development of foam and to allow any foam that did develop to dissipate. The control sample did not contain any lecithin additive. All the samples were stirred to ensure no foam was present. The resulting paints were tested for cleanability using Test Method 1.

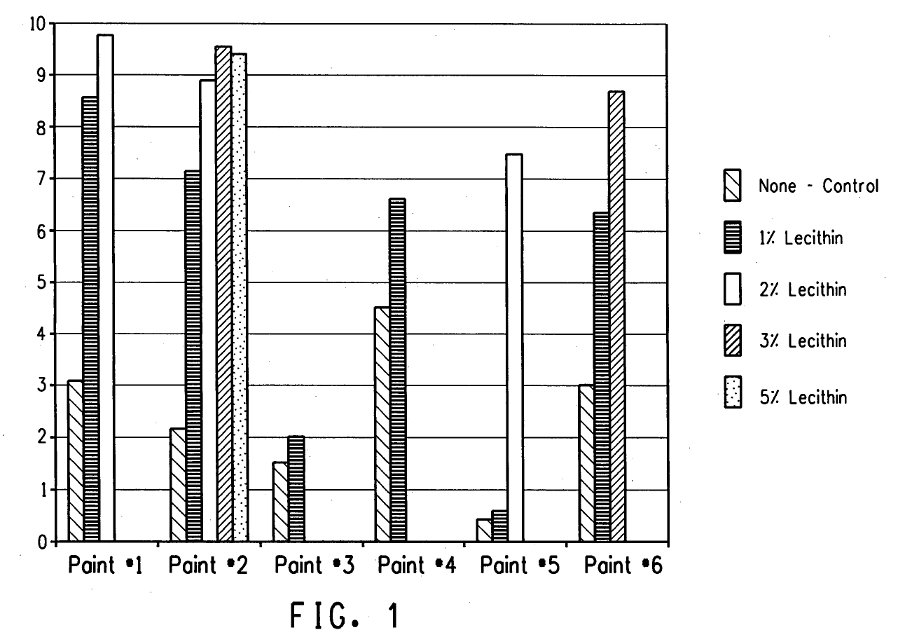

The results are visually depicted in FIG. 1 and the numeral values shown below in Table 1. The values are a relative score of cleanability wherein 0 is uncleanable and 10 is completely cleanable.

TABLE 1
Cleanability Ratings for Leneta Oil

| | Samples | | | | | |
|---|---|---|---|---|---|---|
| | Paint #1 | Paint #2 | Paint #3 | Paint #4 | Paint #5 | Paint #6 |
| None - | 3.1 | 2.2 | 1.5 | 4.5 | 0.5 | 3.0 |
| Control | | | | | | |
| 1% Lecithin | 8.5 | 7.2 | 2 | 6.6 | 0.6 | 6.4 |
| 2% Lecithin | 9.7 | 8.9 | | | 7.4 | |
| 3% Lecithin | | 9.5 | | | | 8.7 |
| 5% Lecithin | | 9.4 | | | | |

Table 1 demonstrates both a 3 point or greater and a 50% or greater improvement in cleanability of coating compositions containing 2% or less lecithin when compared to the control sample for Paint #1, Paint #2, Paint #5 and Paint #6.

### Example 2

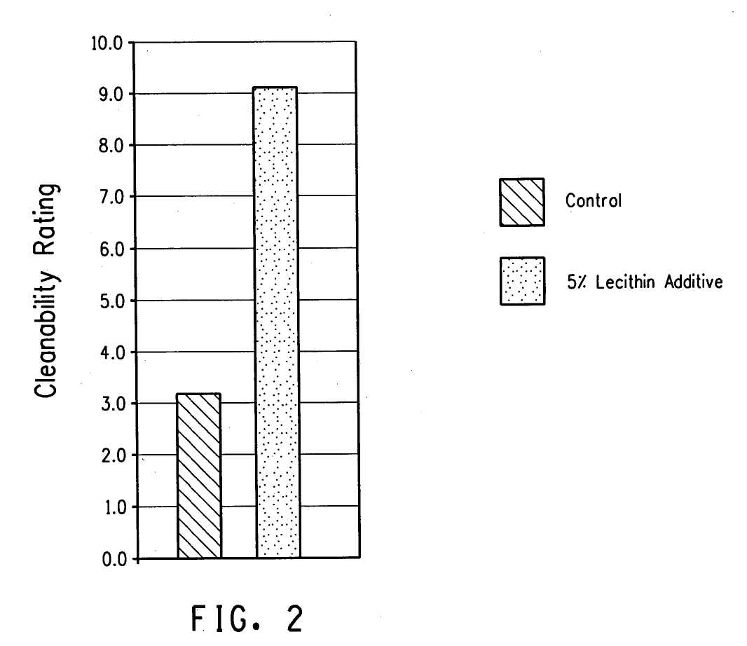

The coating compositions were prepared as in Example 1 and Test Method 1 according to the specifications of Table 2. The base coating composition used was Paint #2 as listed in the Materials section. Control samples were prepared so as not to contain and additional additives, specifically they did not contain addition of lecithin additive. The cleanability test was performed as in Example 1 and according to Test Method 1. The cured coating compositions were stained with LENETA Oil (Leneta Company, Mahwah, N.J.) as described in Example 1 and according to Test Method 1. The results are recorded below in Table 2 and visually depicted in FIG. 2.

TABLE 2
Cleanability Ratings for Leneta Oil

| Coating Combined with | |
|---|---|
| These Additive(s) | Cleanability Rating |
| None - Control | 3.6 |
| 5% Lecithin | 9.6 |

### Example 3

Coating compositions were prepared in a manner similar to Example 1 and having the compositions shown in Table 3. Control samples were prepared so as not to contain and additional additives, specifically they did not contain addition of lecithin additive. Materials and painted MYLAR panels were prepared as described in Test Method 3. Tests were conducted according to Test Method 3 using the coating compositions and stains as described Table 3.

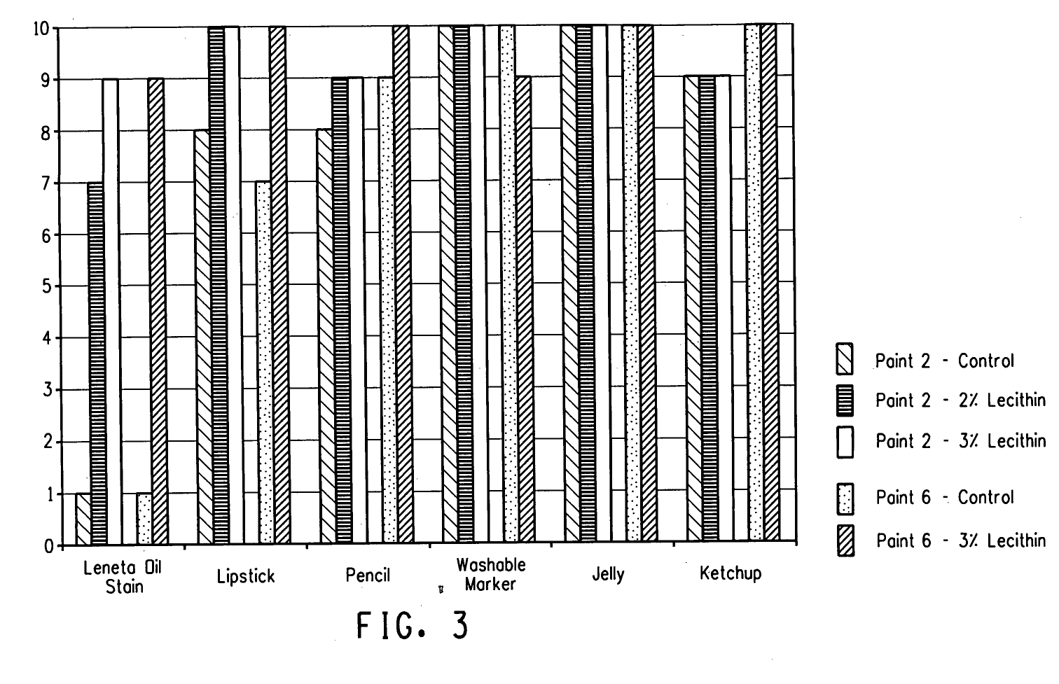

The results are visually depicted in FIG. 3 and the numeral values shown below in Table 3. The values are a relative score of cleanability wherein 0 is uncleanable and 10 is completely cleanable.

TABLE 3
Cleanability Ratings for Household Stain

| | | | Lip- | Pen- | Washable | | |
|---|---|---|---|---|---|---|---|
| Sample | Additive | Crayon | stick | cil | Marker | Jelly | Ketchup |
| Paint | None - | 1 | 8 | 8 | 10 | 10 | 9 |
| 2 | Control | | | | | | |
| | 2% | 7 | 10 | 9 | 10 | 10 | 9 |
| | Lecithin | | | | | | |
| | 3% | 9 | 10 | 9 | 10 | 10 | 9 |
| | Lecithin | | | | | | |
| Paint | None - | 1 | 7 | 9 | 10 | 10 | 10 |
| 6 | Control | | | | | | |
| | 3% | 9 | 10 | 10 | 9 | 10 | 10 |
| | Lecithin | | | | | | |

### Example 4

Coating compositions were prepared in a manner similar to Example 1 and having the compositions shown in Table 4. Control samples were prepared so as not to contain and additional additives, specifically they did not contain addition of lecithin additive. Materials and painted MYLAR panels were prepared as described in Example 1 and Test Method 3. Tests were conducted according to Test Method 3 using the coating compositions and stains as described Table 4.

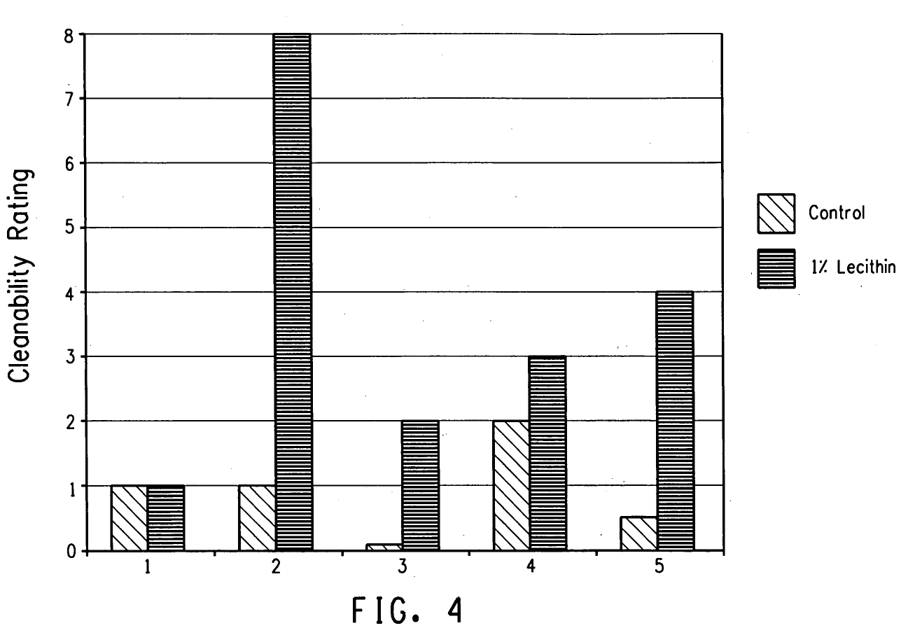

The results are visually depicted in FIG. 4 and the numeral values shown below in Table 4. The values are a relative score of cleanability wherein 0 is uncleanable and 10 is completely cleanable.

TABLE 4
Cleanability Ratings for Crayon

| | Coating Combined with | Cleanability |
|---|---|---|
| Paint | These Additive(s) | Score |
| Paint #1 | None - control | 1.0 |
| | 1% Lecithin | 1.0 |
| Paint #2 | None - control | 1.0 |
| | 1% Lecithin | 8.0 |
| Paint #3 | None - control | 0.0 |
| | 1% Lecithin | 2.0 |
| Paint #4 | None - control | 2.0 |
| | 1% Lecithin | 3.0 |
| Paint #5 | None - control | 0.5 |
| | 1% Lecithin | 4.0 |

### Example 5

Coating composition samples were prepared according to the methods used in Example 1 and Test Method 2. The base coating composition use was paint #2 as listed in the Materials section. Control samples were prepared so as not to contain any additional additives, specifically they did not contain addition of lecithin additive. Experimental samples were prepared to contain lecithin additive 1, as described in Table 5. Experimental samples and control coating compositions were applied to test panels according to Example 1 and Test Method 2.

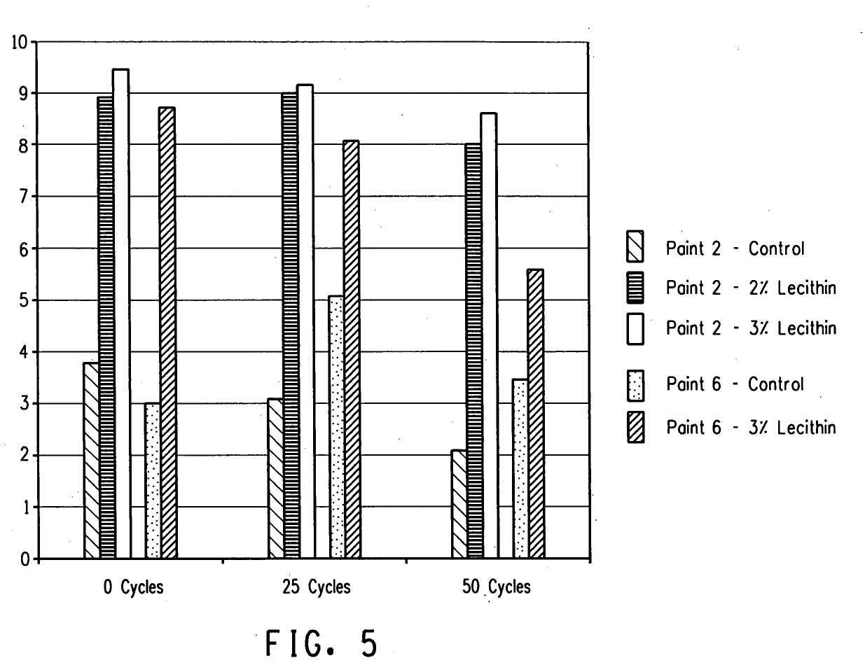

Detergent wash durability tests were performed according the Test Methods 1 and 2 and as specified in Table 5. The results are recorded below in Table 5 and visually depicted in FIG. 5.

TABLE 5
Durability of Cleanability

| Sample | Additive | 0 Cycles | 25 Cycles | 50 Cycles |
|---|---|---|---|---|
| Paint 2 | None - Control | 3.8 | 3.1 | 2.2 |
| | 2% Lecithin | 8.9 | 9.0 | 8.0 |
| | 3% Lecithin | 9.5 | 9.2 | 8.6 |
| Paint 6 | None - Control | 3.0 | 5.1 | 3.5 |
| | 3% Lecithin | 8.7 | 8.1 | 6.5 |

What is claimed is:

1. A coating composition comprising an acylated lecithin additive.

2. The coating composition according to claim 1, wherein the acylated lecithin is present in a concentration of between about 0.1 and about 10.0% by weight of the composition.

3. The coating composition according to claim 1, wherein the acylated lecithin is present in a concentration of between about 0.5 and about 5.0% by weight of the composition.

4. The coating composition according to claim 1, wherein the acylated lecithin is present in a concentration of between about 1.0 and about 5.0% by weight of the composition.

5. The coating composition according to claim 1, wherein the acylated lecithin is an acetylated lecithin additive.

6. The coating composition according to claim 1, wherein the lecithin additive is derived from soybean oil.

7. The coating composition according to claim 1, wherein the composition further comprises a titanium dioxide pigment.

8. The coating composition according to claim 1, further comprising an alkyd coating, a urethane coating, an unsaturated polyester coating, a latex coating or a water dispersible coating.

9. A flat-based water-dispersed coating composition, comprising a lecithin additive present in a concentration between about 0.5 and about 10.0% by weight of the composition, wherein the additive provides improved cleanability.

10. The coating composition of claim 9, wherein the lecithin additive is present in a concentration between about 1.0 and about 5.0% by weight of the composition.

11. The dried coating of claim 1.

12. The dried coating of claim 9.

13. The dried coating of claim 11, wherein the coating demonstrates improved cleanability by 50% or more.

14. The dried coating of claim 11, wherein the coating demonstrates improved cleanability by at least 1 point on a 0 to 10 scale.

15. The dried coating of claim 11, wherein the coating demonstrates improved cleanability by at least 2 points on a 0 to 10 scale.

16. The dried coating of claim 11, wherein the coating demonstrates improved cleanability by at least 3 points on a 0 to 10 scale.

17. A method of providing improved cleanability to a substrate comprising coating the substrate with a coating composition comprising a lecithin additive.

18. The method of claim 17, wherein the lecithin additive is an acylated lecithin additive.

19. The method of claim 18, wherein the acylated lecithin additive is an acetylated lecithin additive.
